(19) United States
(12) Patent Application Publication
(10) Pub. No.: US 2011/0159763 A1
(43) Pub. Date: Jun. 30, 2011

(54) METHOD AND APPARATUS FOR THE MANUFACTURE OF COMPOSITE SHEETS

(75) Inventor: Dominique Loubinoux, La Motte Servolex (FR)

(73) Assignee: SAINT GOBAIN SAINT-GOBAIN FABRICS EUROPE, Chambery (FR)

(21) Appl. No.: 12/824,718

(22) Filed: Jun. 28, 2010

Related U.S. Application Data
(63) Continuation of application No. 10/068,857, filed on Feb. 11, 2002, now abandoned.
Application No. 10/068,857 is a continuation of application No. PCT/FR00/02354, filed on Aug. 22, 2000.

(30) Foreign Application Priority Data
Aug. 27, 1999 (FR) 99/10,842

(51) Int. Cl. D03D 13/00; D03D 15/00; B32B 27/02

(52) U.S. Cl. 442/218; 156/439; 156/178

(57) ABSTRACT

The invention concerns a method for making composite plates which consists in driving along a specific direction a bundle of parallel yarns; associating with this yarn a yarn layer transversely oriented relative to said specific direction, the bundle of yarn and/or yarn layer comprising at least an organic material and at least a reinforcing material, and the assembly comprising at least 10 wt. % of organic material; heating the assembly moving in the specific direction, and fixing it, by heating and/or pressure, then by cooling, so as to form a composite strip; collecting the strips in the form of one or several composite plates. The invention also concerns a device for implementing the method and the resulting product.

The present invention relates to a direct method, and an apparatus for carrying out the said method, for the manufacture of composite sheets. It also relates to the composite products obtained.

Composite sheets are usually formed from at least two materials which have different melting points and which generally comprise an organic material and a reinforcing material, the reinforcing material being, for example, in the form of threads embedded in the organic matrix. The manufacture of composite sheets generally takes a long time between the preparation of the reinforcing threads and the moment when the sheets are finally obtained, the structures used for producing the sheets usually not being the threads, as such, but complex structures incorporating the threads and requiring prior processing steps.

In particular, it is already known to manufacture composite sheets in the form of panels or of curved pieces from fabrics formed both from reinforcing threads and from thermoplastic threads, in that the fabrics are stacked and the stack thus produced is then hot-pressed, as described in the utility model 2,500,360. Such a method has, in particular, the disadvantage of being a discontinuous method.

It is also known (patent FR 2,743,822) to manufacture composite sheets from glass/organic material fabrics which are deposited continuously onto a conveyor and are then preheated in a hot-air oven, before being introduced into a “band press” (of the type described in the U.S. Pat. No. 4,277,539), where they are successfully heated and cooled, whilst at the same time being compressed. Although this method is quicker than the method described above, it is desirable to improve the manufacture of composite sheets even further by providing quicker and more economical methods, whilst at the same time ensuring that products preserving good properties, in particular mechanical properties, are obtained.

The object of the present invention is to provide a method which is improved, as compared with existing methods, for the manufacture of composite sheets, in particular a quicker and more economical method than the existing methods.

This object is achieved by means of the method according to the invention, comprising at least the following steps:
a bundle of parallel threads is driven in a given direction,
a lap of thread or threads oriented transversely relative to this given direction is combined with this bundle, the bundle of threads and/or the lap of thread or threads comprising at least one organic material and at least one reinforcing material,
the combination is heated, being displaced in the given direction, and is fixed (or set) by the action of heat and/or of pressure, then by cooling, so as to form a composite band,
the band is collected in the form of one or more composite sheets.

The various steps, such as the driving of the bundle, the combining of the lap, etc., advantageously take place continuously, this term also embracing intermittent drive and combination, as in the case of combination with a carriage (this embodiment being explained later).

By “sheet” (and likewise by “band”) is meant, according to the present invention, an element of small thickness in relation to its surface, generally plane (but, where appropriate, possibly being curved) and rigid, although having, as required, sufficient flexibility to be capable of being collected and stored in wound-up form. In general, it is a solid element, but, in some cases, it may be perforated (the term “sheet” and the term “band” thus also, by extension, designate structures of the netting or fabric type, according to the invention).

By “composite” is meant, according to the present invention, the combination of at least two materials of different melting points, including in general an organic material and a reinforcing material, the content of the lower melting point material (the organic material) being at least 10% by weight of the said combination.

The method according to the invention makes it possible to obtain composite sheets in a single operation from simple starting structures; in fact, the method according to the invention essentially employs unidirectional structures or threads; in particular, the reinforcing material used in the method according to the invention is provided solely in the form of threads, separate from one another and unconnected within “complex” structures (in particular, “multi dimensional” structures of the fabric or netting type). The use of the simplest reinforcing structures in the manufacture of the sheets according to the invention has advantages particularly in terms of cost and of ease of use. From these simple structures, the method according to the invention makes it possible to obtain the desired sheets directly, with little labour being required and with the transfers from one installation to another and the intermediate storages being dispensed with. It combines, in particular, a step of assembly in a plane transverse to the given direction and a step of melting and solidifying the organic material in order to culminate in the finished product. Such a method is particularly quick and economical.

Reference will simply be made, hereafter, to the bundle of threads” in order to designate the bundle of parallel threads which is driven continuously in a given direction, the said bundle being mentioned in the definition of the invention, and “the lap of thread or threads” will designate the lap of transversely oriented thread or threads, the said lap being mentioned in the definition of the invention, that is to say, more specifically, one or more threads distributed transversely on the surface defined by the bundle of parallel threads.

According to the invention, at least the bundle of threads or at least the lap of threads is formed from threads of at least two materials which comprise at least one organic material and at least one reinforcing material, this “reinforcing material” generally being a material selected from the materials commonly used for the reinforcement of organic materials (such as glass, carbon, aramid, etc.) or being capable, where appropriate, of being understood in a broad sense as a material having a melting point higher than that of the abovementioned organic material; in other words, at least the bundle of threads or at least the lap of threads is formed from threads of at least two materials having different melting points, the material with the lower melting point being an organic material. The organic material is, for example, polypropylene, polyethylene, polybutylene terephthalate, polyethylene terephthalate, phenylene polysulphide or any other thermoplastic or polymeric organic material selected from thermoplastic polyesters, polyamides, etc., the reinforcing material or the material with the higher melting point preferably being glass.

Preferably, the bundle and the lap are selected in such a way that the combination of the bundle and of the lap comprises at least 10% by weight of organic material and between 20 and 90% by weight of reinforcing material (preferably glass), preferably between 30 and 85% by weight of reinforcing material, and, in a particularly preferred way, between 40 and 80% by weight of reinforcing material. Particularly advantageously, the combination of the bundle and of the lap consists of the reinforcing material, in the proportions mentioned, and of the organic material in a proportion representing the complement to 100% by weight of the said combination. The bundle and/or the lap may comprise partially threads consisting of one of the materials and partially threads consisting of the other material, these threads being arranged alternately in the bundle and/or the lap and being preferably intimately mixed. The bundle and/or the lap may also comprise mixed threads obtained by the joining and simultaneous winding of the threads of one of the materials and of the threads of the other material, these mixed threads likewise being capable of being blended with threads of one of the materials and/or with threads of the other material.

Preferably, the combination of the bundle and of the lap and/or the bundle and/or the lap comprises at least 50% (advantageously at least 80% and, in a particularly preferred way, 100%) by weight of co-blended threads, that is to say of threads composed of filaments of one of the materials and the filaments of the other material, the filaments being blended within the threads (advantageously in an approximately homogeneous way), these threads generally being obtained by assembling the filaments directly at the time of the manufacture of the said filaments (according to the methods described, for example, in the patents EP 0,599,695 and EP 0,616,055). The use of these structures having at least 50% and preferably at least 80% by weight of co-blended threads makes it possible, in particular, to obtain more homogeneous composite products having good mechanical properties, the production of the composite sheets taking place, furthermore, within a reduced time and advantageously at lower pressure. Preferably, these co-blended threads consist of glass filaments and of filaments of thermoplastic organic material, the said filaments being intimately mixed.

Preferably, the bundle of threads consists essentially of co-blended threads and the lap of threads consists of continuous (generally parallel) or cut co-blended threads and/or of continuous (generally parallel) or cut reinforcing threads and/or of continuous (generally parallel) or cut threads of organic material.

In the method according to the invention, the threads of the bundle and the threads of the lap most often emanate from one or more supports (or packages) on which they are wound, the threads of the lap being cut, as required, before being combined with the threads of the bundle.

The bundle and the lap can be combined in various ways, for example by means of one or more depositing arms or by means of a carriage carrying the threads of the lap which are arranged in parallel or by depositing the threads pneumatically (if appropriate, with the formation of loops or of a mat) or by depositing the cut threads, etc.

According to a first embodiment, combination takes place by the lap of threads (in this case, they are preferably continuous threads) being incorporated transversely into the bundle of parallel threads, the bundle being, in this particular case, separated into two parts (one part being vertically in line with the other, for example one thread out of two being temporarily raised relative to the initial plane of the bundle and, if appropriate, the other threads being temporarily lowered relative to the initial plane) delimiting a space, within which the threads are projected with the aid of a rapier loom. This loom comprises, for example, two rapiers equipped with grippers, one rapier introducing, for example, the threads of the lap into the middle of the bundle and the second rapier extracting the threads from the other side of the bundle, the threads then being cut. The loom may also comprise a single rapier.

According to a second embodiment, a carriage carrying the lap of threads in the form of parallel continuous threads delivers the lap into the bundle of parallel threads, the lap and the bundle subsequently being, if appropriate, sewn to one another by means of binding threads delivered continuously (for example, fine threads of polyester or of polypropylene or of glass). These binding threads are put to use, for example, by means of the periodic movement of a transverse needle bar. Contrary to the previous embodiment, the threads of the lap and of the bundle are not intermingled, but are simply bound to one another. The products obtained in this case have good alignment (and therefore little shrinkage) and a high degree of deformability.

According to a third embodiment, combination takes place by the lap of threads (in this case, these are likewise preferably continuous threads) being incorporated transversely into the bundle of parallel threads with the aid of a netting loom with weft insertion by a rotary arm or rotary arms. This loom may comprise one or more rotary arms, the threads of the lap coming either from a bobbin or bobbins arranged on the wheel carrying the depositing arms, this wheel being driven in rotation, or from a bobbin or bobbins arranged on another support in movement (synchronous with the movement of the depositing arms) or from a stationary bobbin or stationary bobbins, in this case the arm or arms being generally hollow arms with an axial passage. The products obtained in this embodiment have very little shrinkage and very good mechanical properties.

According to a fourth embodiment, combination takes place by the threads being cut above the bundle of parallel threads, the cut threads being oriented in various directions, particularly in directions transverse to that of the bundle of threads, the cut threads forming a lap which is superposed on the bundle of threads. Preferably, in this embodiment, the threads fall onto one or more deflectors (as a rule, a metal plate, or, if appropriate, a plurality of metal plates, inclined at an angle of the order of 45 to 80° relative to the bundle of threads), making it possible to orient them more accurately in directions transverse relative to the given direction, before they are distributed on the bundle of parallel threads.

According to a fifth embodiment, combination takes place by one or more threads being projected transversely in the form of a mat onto the bundle of parallel threads, the lap of threads in the form of the mat being, if appropriate, covered by a second bundle of parallel threads which is displaced in the same direction as the first bundle of parallel threads.

The combination of the bundle and lap of threads (displaced at a speed of, for example, between 0.5 and 10 m/min) passes into at least one zone, where it is heated to a temperature between the melting points of the materials forming the combination, this temperature also being below the degradation temperature of the material having the lowest melting point. In the present invention, the “degradation temperature” designates, by extension, the minimum temperature at which decomposition of the molecules making up the material is observed (as traditionally defined and understood by the average person skilled in the art) or an undesirable change in the material, such as an inflammation of the material, a loss of intactness of the material (resulting in the material flowing out of the lap) or an undesirable colouring of the material (for example, yellowing), is observed. This degradation temperature can be evaluated in the traditional way by thermogravimetry and/or by noting the minimum temperature at which one of the abovementioned effects occurs.

In the present invention, the combination is heated sufficiently to make it possible for at least some of the threads to be bound to one another by means of the material with the lowest melting point, after heating and/or compression, and, in most cases (except when a structure of a netting type is desired instead), to make it possible to obtain a solid or approximately solid structure.

As examples, the heating temperature may be of the order of 190 to 230° C. when the lap of threads consists of glass and of polypropylene, it may be of the order of 280 to 310° C. when the lap consists of glass and of polyethylene terephthalate (PET), and it may be of the order of 270 to 280-290° C. when the lap consists of glass and of polybutylene terephthalate (PBT).

The combination may be heated in several ways, for example with the aid of a double-band laminating machine, or with the aid of heated cylinders or of an irradiation device, such as an infrared radiation device (for example, in the form of an infrared oven or lamp or lamps or panel or panels), and/or at least one hot-air blowing device (for example, a forced-convection hot-air oven).

Heating may be sufficient to make it possible to fix the combination by means of the melted organic material (thermofixing). In many cases, however, the heated combination also undergoes compression with the aid of a compression device, for example with the aid of at least one two-roll calender. The force exerted on the combination during its passage through the compression device, for example during its simultaneous passage between two rolls of a calender, is generally several kgf/cm, even several tens of kgf/cm. The pressure exerted in the compression device compacts the lap of threads, the structure obtained being set by cooling, this cooling being capable of being carried out, at least partially, simultaneously with the compression or also being capable of being carried out after a hot-compression step.

The compression device may comprise at least one calender, in particular a calender maintained at a temperature below the solidification point of the material with the lowest melting point (the calender is, for example, at a temperature of between 20 and 150° C.), in order to solidify the said material. The compression device may also comprise a plurality of calenders, particularly where large thicknesses are concerned and if it is desirable to have very good planeness and/or high production speeds. Moreover, particularly when use is made of materials with high melting points or having a high crystallization rate (for example, polyesters), and when the aim is to obtain solid or approximately solid sheets, it may be desirable to heat the calender (or at least the first calender) of the compression device to a temperature higher than 75° C., preferably higher than 100° C., even higher than 150° C. In this case, the rolls of the heated calender are preferably covered with an anti-adhesive covering based, for example, on PTFE and/or a mould release film (made of silicone-coated paper or of glass cloth coated, for example, with PTFE) is unwound between each roll and the lap of threads (this film may, if appropriate, be in the form of an endless band).

According to one embodiment of the invention, the compression device may also comprise or consist of a band press (equipped, for example, with bands of steel or of glass cloth or of aramid cloth, the cloth preferably being coated with PTFE) comprising a hot zone (in particular, with one or more calenders) followed by a cold zone (with cooling elements in the form of bars, plates, etc. and, if appropriate, one or more calenders).

Cooling may take place in the compression device (for example, in a cold calender or in the cold zone of a double-band flat laminating machine) or may take place outside the compression device, for example by natural or forced convection. In order to accelerate its cooling, the composite band obtained at the exit of the above-mentioned compression device can pass onto a cooling table, in which cold water circulates, this table, if appropriate, being slightly curved convexly, in order to improve contact with the band. In order to improve cooling and/or contact even further, the table may be combined with press rollers, preferably cooled (for example, by water circulation), and/or with one or more freely bearing or pressed cooled plates and/or with one or more air-blowing nozzles, and/or the band may be drawn by take-up rollers located, for example, at the exit of the table.

The composite band, after being compressed and cooled, can be wound onto a mandrel, the diameter of which is a function of the thickness of the band (the sheet formed then corresponds to the wound band), or can be cut by a cutting device (for example, a guillotine or circular-saw device), so as to form a plurality of sheets.

Although the present method is essentially described in terms of the combination of one lap of threads and of one bundle of parallel threads, it is quite clear that a plurality of laps may be combined with one or more bundles of threads in the same way as described above. It is possible, in particular, to combine a plurality of laps of threads in order to form sheets of greater thickness. Thus, according to one embodiment of the invention:
a first bundle of parallel threads is driven in a given direction,
a lap of threads oriented transversely relative to this given direction is combined with this first bundle,
at least one second bundle of parallel threads is combined with the bundle and with the lap in the given direction, the first bundle of threads and/or the lap of threads and/or the second bundle of threads comprising at least two materials having different melting points,
the combination is heated, being displaced in the given direction, and is fixed by the action of heat and/or of pressure, then by cooling, so as to form a composite band,
the band is collected in the form of one or more composite sheets.

It is also possible, before compression of the assembly, to unwind one or more surface films onto one or two faces of the combination, these films adhering under hot conditions to the combination of the bundle(s) and lap(s). These films may be of a material or materials identical to or different from those (or one of those) of the threads of the combination (they may be metallic, organic, etc.), these films preferably being of a nature or having a covering of a nature close to the nature of the material of lowest melting point present in the combination.

In more general terms, it is possible to apply to the surface of the combination and/or introduce into the combination other structures in the form of threads or an assembly of threads, cellular structures, or structures containing elements in the form of powder, of granules or of liquid, leaves or panels or films, of an essentially metallic or polymeric or mineral or vegetable nature, which are continuous or discontinuous, and imparting particular properties to the composite sheets obtained (additional reinforcement by means of threads of different nature, improvement in the mechanical properties, protection against electromagnetic radiation, improvement in thermal or acoustic insulation, lightened composite structures, improved moulding capacity, surface appearance, etc.).

The band obtained in the method according to the invention may be collected in the form of packages (that is to say, as it were, in the form of a single wound composite sheet) or of a plurality of sheets cut to the dimensions required by the users.

The present invention also relates to an apparatus for carrying out the method.

This apparatus comprises:

a) one or more devices (or members) for feeding at least one bundle of parallel threads,

b) one or more devices (or members) for feeding at least one lap of threads,

c) one or more devices for orienting the threads of the lap transversely to the direction of the parallel threads of the bundle (for example, according to the embodiment, a rapier loom, a carriage loom, a netting loom with weft insertion by rotary arms, or a deflector, as described in the various embodiments explained above),

d) at least one device (or member) for heating the combination of the bundle and of the lap,

e) and at least one device for cooling the combination.

The apparatus according to the invention may also comprise at least one compression device and/or at least one cutting device and/or at least one device for collecting the composite sheets. The cooling device may also be a compression device, or the apparatus according to the invention may comprise at least one device for compressing the combination of the bundle and of the lap separate from the cooling device.

The composite sheets obtained as a result of the combination of steps of the method according to the invention are particularly economical and comprise filaments of a material having a higher melting point (generally reinforcing filaments) which are embedded in the sheet and are arranged, generally with regard to at least part of them, in the direction of travel of the sheet during its manufacture and, preferably likewise with regard to the other part (or at least another part of these filaments) in a direction transverse to the direction of travel. The sheet thus comprises at least one assembly of filaments of a material having a higher melting point, which are arranged approximately parallel in a first direction, and, if appropriate, at least one second assembly of filaments of a material having a higher melting point, which are arranged approximately parallel in a second direction preferably transverse to the first, all these filaments being embedded in the material having a lower melting point. The sheets obtained generally have a thickness of between a few tenths of a millimetre and approximately 2 mm, are rigid and easy to cut and have good mechanical properties. They may be used as such in moulding methods or in combination with other products. They may be used, for example, for the thermoforming and the moulding of pieces made of composite products.

As a general rule, the sheets obtained have little shrinkage (the ratio between the length of the thread in one direction and the length of the sheet in this direction, this ratio being evaluated with regard to threads passing through the sheet in this direction and not with regard to cut threads) in each of the preferred directions of orientation of the threads, the shrinkage generally being below 6%, or even 2% or 1%, in at least one direction. With regard to sheets obtained, using a netting loom with weft insertion by rotary arms, even the complete or virtually complete absence of shrinkage can be seen.

Other advantages and characteristics of the invention may be gathered from the following drawings which illustrate the invention, but without limiting it, and in which:

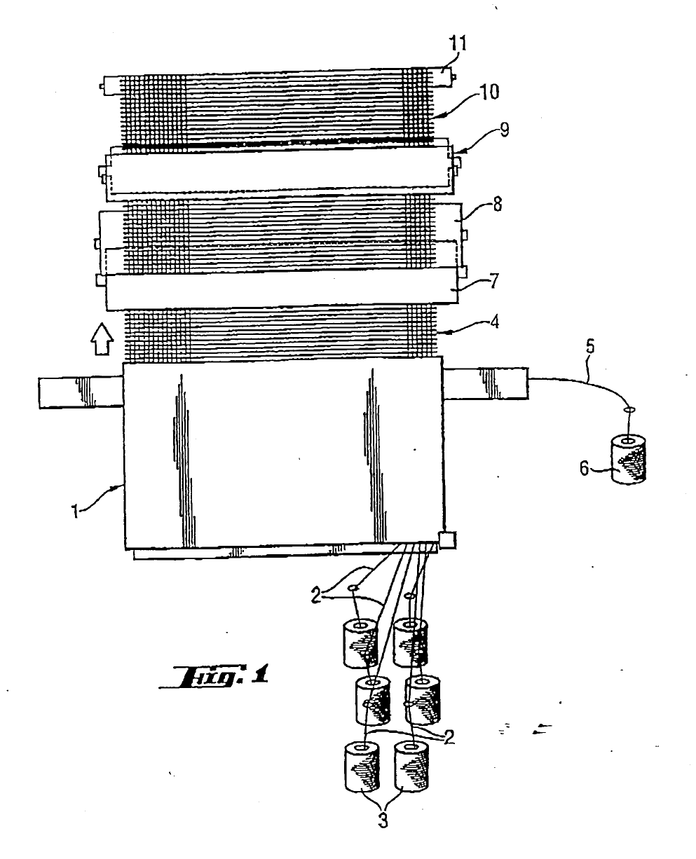

FIG. 1 shows a diagrammatic view of an apparatus allowing a first implementation of the invention,

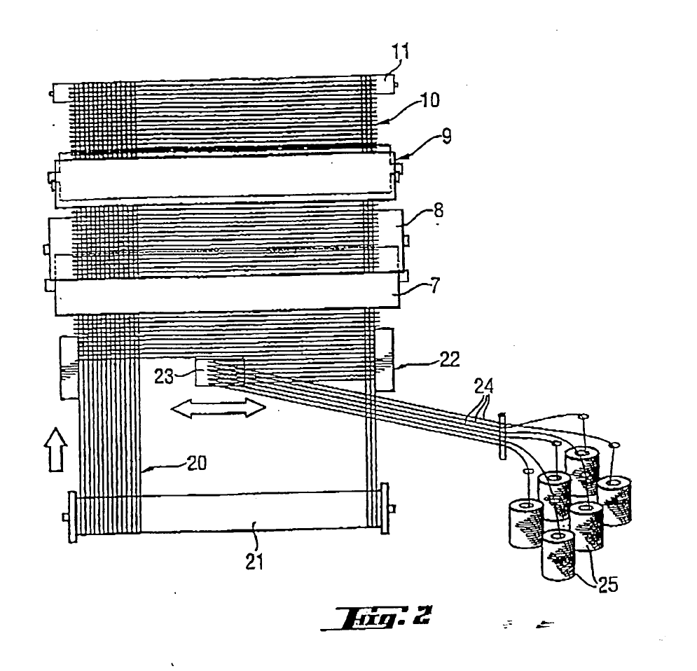

FIG. 2 shows a diagrammatic view of an apparatus allowing a second implementation of the invention,

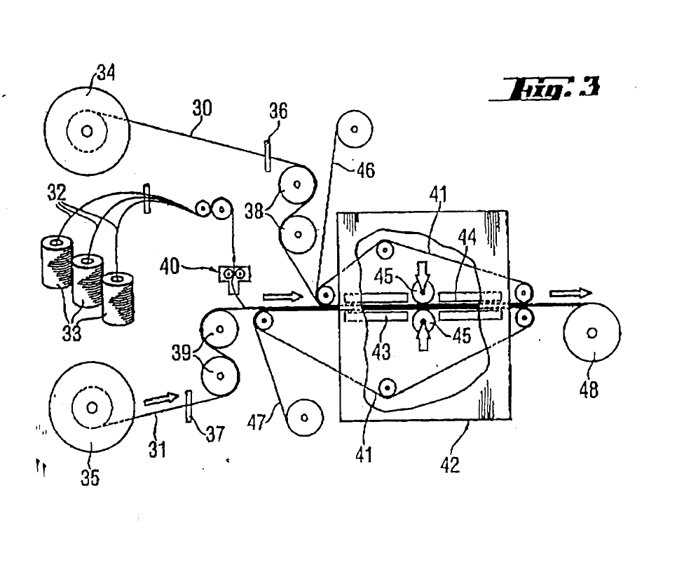

FIG. 3 shows a diagrammatic view of an apparatus allowing a third implementation of the invention,

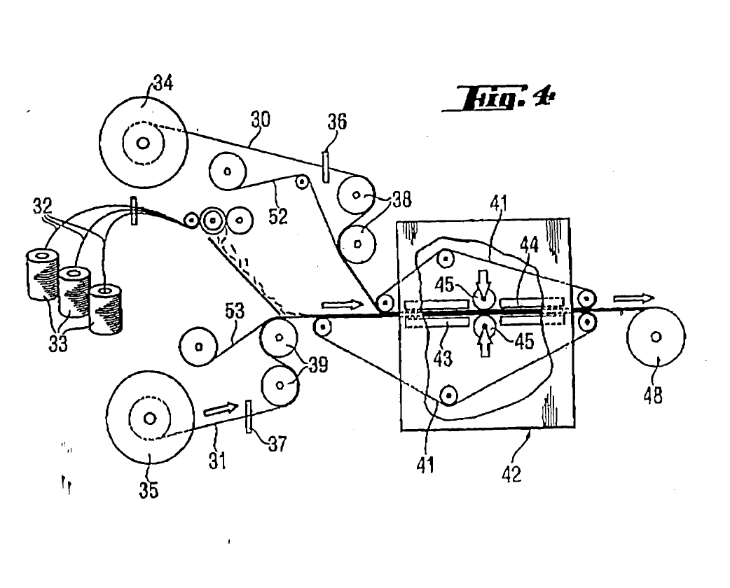

FIG. 4 shows a diagrammatic view of an apparatus allowing a fourth implementation of the invention,

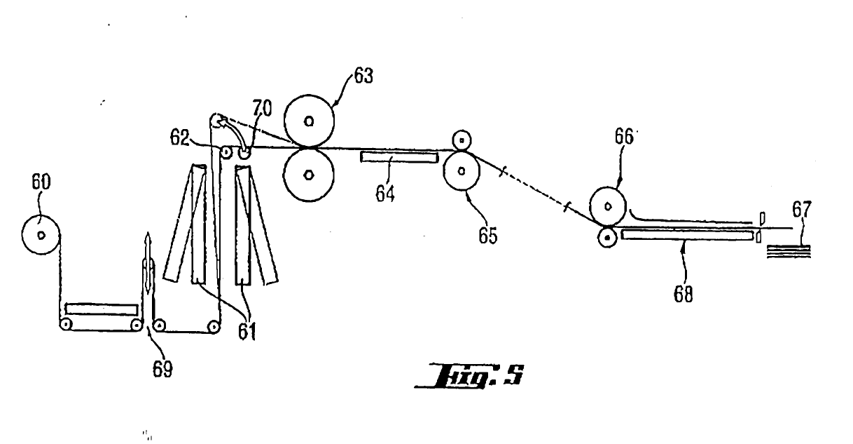

FIG. 5 shows a diagrammatic view of part of an apparatus for implementing the invention,

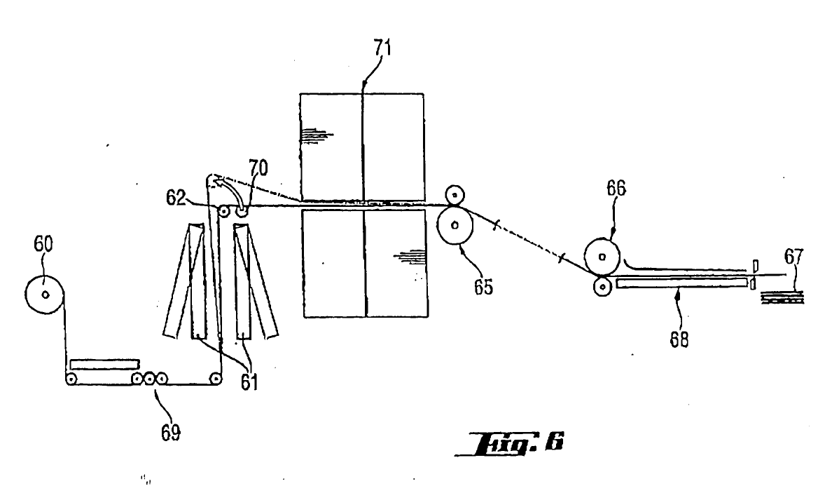

FIG. 6 shows a diagrammatic view of part of an apparatus for implementing the invention.

In the method illustrated in FIG. 1, a double-rapier weaving loom 1 is fed with a bundle of threads 2 (having, for example, 4 threads per cm) which come from rovings 3, the threads passing through a comb and arriving in parallel in the weaving loom (a part which is not visible and is not shown in the figure), these threads being, for example, composite threads composed of glass filaments and of polypropylene filaments blended with one another.

A fabric 4 is manufactured by the insertion, for example at 120 strokes/mn, of a thread 5 (coming from a roving 6 and likewise composed of glass filaments and of polypropylene filaments) per cm, in the form of a cloth-like assembly.

The fabric passes under a first cylinder 7 heated, for example, to 200° C. and having, for example, a diameter of the order of 300 mm, and then passes over a second heated cylinder 8. The polypropylene filaments melt in contact with the hot surfaces. The product then passes into the nip of a calender 9, thermostatically controlled at, for example, 40° C., where it is cooled and converted into a sheet 10, for example with a thickness of about 0.7 mm, composed, for example, of 40% by weight of polypropylene and of 60% by weight of glass filaments oriented in two perpendicular directions. It is subsequently, for example, wound onto a tube 11 having a diameter of 100 mm.

In FIG. 2, a bundle 20 of parallel composite threads composed, for example, of glass filaments and of polypropylene filaments is unwound from one or more beams 21 and is introduced into a knitting machine 22 equipped with a weft insertion carriage 23 capable of taking up a plurality of threads 24 simultaneously (these threads having come from rovings 25 and likewise being composite threads) and of depositing them transversely to the direction of displacement of the bundle of threads, for example at the rate of 2 threads per cm.

These threads 24 may be bound to the threads of the bundle by means of a simultaneous knitting operation the binding threads being products having a linear density, or mass per unit length, of less than 50 tex (g/km). The sewn product subsequently passes into a consolidation device similar to that of FIG. 1.

In an economical variant which does not employ binding threads, a second bundle of threads is brought onto the lap of threads deposited by means of a carriage, in order to block them. The non-sewn assembly is subsequently directly onto the conveyed consolidation and winding system.

In another more elaborate variant, use is made of a plurality of weft insertion carriages which are movable in the plane along two axes and which make it possible to produce multi-layer surfaces having a plurality of directions, for example 0°/−45°/+45°/90°. These thicker products may or may not be bound by knitting and may be directly consolidated in line by melting and cooling under pressure or simply thermofixed by melting/cooling, without pressure being applied.

FIG. 3 describes a method for the manufacture of a plane product in the form of a consolidated glass/thermoplastic composite product, in which use is made of two bundles of composite parallel threads 30 and 31 and a lap of composite threads 32 which come from rovings 33 deposited transversely in the form of a mat having continuous threads.

The bundles of parallel threads may come from creels, not shown in FIG. 3, or be wound on beams 34 and 35, these threads passing through combs 36, 37 keeping them parallel, then through take-up cylinders 38, 39 making it possible to reduce the tensions of the threads, before these enter the consolidation device.

A plurality of threads 32 are deposited between these bundles by means of a carriage 40 which is displaced transversely to the direction of displacement of the bundles in an alternating movement, in order to form a mat (or a lap of looped threads). This carriage is, for example, equipped with a cylinder-type take-up system coupled to a compressed-air ejector having a Venturi effect.

The combination of the bundles and of the lap subsequently passes between the-continuous bands 41 (made of glass fabrics impregnated with polytetrafluoroethylene-PTFE-) of a flat laminating press 42. This laminating press comprises a heating zone 43 and a zone 44 cooled by water circulation and, between these two zones, pressing cylinders 45 which compress the melted thermoplastic material under a pressure in the vicinity of, for example, 10 to 20 N/cm².

At the exit of this double-band press, the product has a homogeneous appearance, this appearance being capable of being improved, for example, by two polypropylene films 46 and 47 deposited on either side of the combination between the bands of the press. The rigid sheet obtained is subsequently either wound onto a tube 48 having a diameter of, for example, 100 mm or is cut continuously into a plurality of rectangles by means of blades and an automatic shearing machine which are not shown.

In one variant, the double-band press is replaced by a device comprising two heated rollers covered with PTFE, followed by a calender having two cooled cylinders. The two polypropylene surface films 46 and 47 are, in this case, preferably introduced into the nip of the cold calender.

The method shown in FIG. 4 closely resembles that shown in FIG. 3 (the same references being adopted again for the same elements). The difference is in the type of mat which is sandwiched between the two warps of parallel threads. Here, this mat is, for example, formed by threads 50 of pure glass which are cut to a length of 50 or 100 mm and are oriented in the transverse direction by means of a deflecting plate 51. Two polypropylene films 52 and 53 having a thickness of, for example, 50 μm may, if appropriate, be introduced on either side of this mat. Two other polypropylene films, not shown, may also be added on each side of the product, in order to improve its surface appearance. The product obtained may be wound or cut into sheets.

The cut-thread mat may also consist of the thread of the same nature as that of the threads of the bundle (for example: 60% glass and 40% polypropylene). In this case, there is no need to introduce films 52 and 53 into the core of the product.

That part of the apparatus which is shown in FIG. 5 is a variant of the “consolidation” part of the methods shown in FIGS. 1 and 2. It follows, for example, a weaving or knitting loom with weft insertion 60. The organic part is melted contactlessly by means of two infrared radiation panels 61 which are retractable in order to avoid the risks of the combination being damaged (or burnt) during stoppages of the loom. After the partially melted product has been deflected on a thermostatically controlled bar 62, the said product is compacted and cooled in the nip of a calender 63, for example at 40° C., and then passes, if appropriate, over a convexly-curved cooling table 64. The product, driven by rollers 65, 66, is subsequently cut into sheets 67 with the aid of one or more cutting devices 68.

Where a shutdown of the weaving (or knitting) loom is concerned, an accumulator 69 draws to the rear that part of the product which is located between the end of the infrared panels and the entrance of the calender, so as not to have zones of non-compacting product corresponding to each stoppage. Moreover, in order to avoid the product being damaged on the deflecting bar, thermostatically controlled at, for example, 220° C., a move-away bar 70 moves the product away.

The method in FIG. 6 is a variant of the method described in FIG. 5 and leads to products which are simply thermofixed, without consolidation. The previous system of compacting/cooling by calender and convexly-curved cooling table is replaced, here, by air-blowing boxes 71.

The sheets produced according to the present invention are particularly suitable for the production of composite articles by moulding.

1-16. (canceled)

17. An apparatus for manufacturing a composite sheet comprising:
at least one first supplying device for supplying at least one bundle of parallel threads in a first direction into a combining device;
at least one second supplying device for supplying at least one lap of thread(s) into the combining device, wherein the combining device combines the at least one bundle of parallel threads and the at least one lap of thread(s) so that the thread(s) of the at least one lap of thread(s) are oriented in a second direction that is substantially transverse to the first direction to provide a combination of threads; and
at least one feeding device for feeding the combination of threads through at least one heating device to heat the combination of threads and at least one cooling device to cool the heated combination of threads to provide a composite sheet.

18. The apparatus of claim 17, further comprising one or more of a compression device for compressing the combination of threads, a cutting device for cutting the composite sheet, or a device for collecting the composite sheet.

19. The apparatus of claim 17, wherein the combining device is a rapier loom, a carriage loom, a netting loom with a weft insertion by rotary arms, or a deflector.

20. The apparatus of claim 17, further comprising an accumulator or move-away bar to draw the product away from the heating device if the apparatus stops feeding.

21. A composite sheet comprising a thermoplastic organic material and at least one reinforcing thread prepared by:
providing a first bundle of parallel threads moving in a first direction;
combining the moving bundle of parallel threads with a lap of thread(s), wherein the lap of thread(s) is oriented in a second direction that is substantially transverse to the first direction, to provide a combination of threads;
heating the combination of threads, optionally applying pressure to the combination of threads, and cooling the combination of threads to provide a composite sheet; and collecting the composite sheet,
wherein at least one of the bundle of parallel threads or the lap of thread(s) comprises at least on organic material and at least on reinforcing material and shrinkage of the composite sheet is less than 6 percent.

22. A method of manufacturing a composite sheet comprising:
providing a first bundle of parallel threads moving unidirectionally in a first direction;
placing a lap of thread(s) on a surface of the moving bundle of threads with a weft insertion carriage, wherein the lap of thread(s) is a single layer of continuous thread(s) oriented in a second direction that is transverse to the first direction, to provide a first combination of threads having a first layer comprising the moving bundle of threads and a second layer comprising the lap of thread(s);
combining the first combination of threads with a second bundle of parallel threads moving in the first direction to provide a second combination of threads having, in the following order, a first layer comprising the moving bundle of threads, a second layer comprising the lap of thread(s) and a third layer comprising the second bundle of parallel threads, wherein the threads of the first layer, second layer, and third layer are separate and unconnected from threads in any other layer,
wherein the second combination of threads comprises at least 50% by weight of co-blended threads consisting essentially of intimately mixed glass filaments and filaments of at least one thermoplastic organic material; then heating the second combination of threads, optionally applying pressure to the second combination of threads, and cooling the second combination of threads to provide a solid composite sheet; and
collecting the solid composite sheet,
wherein at least one of the first bundle of parallel threads, the second bundle of parallel threads, or the lap of threads comprises the at least one thermoplastic organic material, and at least one reinforcing material, and at least one of the first bundle of parallel threads, the second bundle of parallel threads, or the lap of threads comprises at least two materials having different melting points,
wherein the combination of threads comprises at least 10 percent of the thermoplastic organic material, and
wherein the composite sheet comprises solely the first bundle of parallel threads, the lap of threads, and the second bundle of parallel threads.

23. The method according to claim 22, further comprising introducing into the combination of threads, introducing into the second combination of threads, placing on the surface of the combination of threads, or placing on the surface of the second combination of threads one or more additional materials to provide additional reinforcement, improve the mechanical properties, protect against electromagnetic radiation, improve molding capacity, improve surface properties, or reduce the weight of the composite sheet.

24. The method of claim 22, comprising applying pressure to the combination of threads after heating.

25. The method of claim 22, wherein the lap of threads consists of continuous threads of organic material.

26. The method of claim 22, wherein the composite sheet comprises polypropylene and glass filaments in perpendicular orientation.

27. The method of claim 22, wherein each of the moving bundle of threads, the lap of threads, and the second bundle of parallel threads are continuous threads.

28. The method of claim 22, wherein the combination of threads comprises between 50 and 80% of reinforcing material.

29. The method of claim 22, wherein the composite sheet has a thickness of between a few tenths of a millimeter and approximately 2 mm.

30. The method of claim 22, wherein the composite sheet has a thickness of from 0.7 to 2 mm.

31. The method of claim 22, wherein the co-blended threads consist of threads of the glass filaments and the filaments of the at least one thermoplastic organic material.

32. The method of claim 22, wherein the first bundle of parallel threads is a single layer of continuous threads.
